(19) United States
(12) Patent Application Publication
(10) Pub. No.: US 2026/0064041 A1
(43) Pub. Date: Mar. 5, 2026

(54) IMAGE FORMING APPARATUS

(71) Applicant: CANON KABUSHIKI KAISHA, Tokyo (JP)

(72) Inventors: Naoki Hayashi, Kanagawa (JP); Yukio Kubo, Tokyo (JP); Isao Koishi, Kanagawa (JP); Shunsuke Hijikata, Kanagawa (JP); Yuuji Obukuro, Saitama (JP); Yu Fukasawa, Tokyo (JP)

(21) Appl. No.: 19/305,029

(22) Filed: Aug. 20, 2025

(30) Foreign Application Priority Data
Aug. 28, 2024 (JP) 2024-146334

(51) Int. Cl. G03G 15/08; G03G 15/04; G03G 21/16; G03G 21/20

(52) U.S. Cl. CPC G03G 15/0877; G03G 15/04072; G03G 15/0891; G03G 21/1647; G03G 21/206; G03G 2215/0404; G03G 2221/163

(57) ABSTRACT

An image forming apparatus includes a plurality of pipes through which developer passes. The developer is conveyed from a plurality of developer containers to a plurality of developing units. The plurality of pipes includes a first pipe that extends to a first receiving port of a first developing unit from a first communication port of an attachment portion to and from which a first developer container is attachable and detachable. The developer from the first discharge port of the first developer container passes through the first pipe. The first developer container and the first pipe are provided respectively, in a second direction orthogonal to a first direction, at a position closest to a first end surface among the plurality of developer containers and the plurality of pipes. At least a part of the first communication port overlaps the first receiving port when viewed in the first direction.

### BACKGROUND

### Field of the Technology

The present disclosure relates to an image forming apparatus that replenishes developer from developer replenishment containers attachable to and detachable from the image forming apparatus.

### Description of the Related Art

In an electrophotographic image forming apparatus, it is known to use toner cartridges, which are toner containers (developer containers) attachable to and detachable from the image forming apparatus, to replenish toner (developer) into the developing containers (main body accommodation portions) of developing units inside the image forming apparatus. Japanese Patent Application Laid-open No. 2023-007030 discloses a configuration in which toner cartridges are attached to an image forming apparatus, thereby allowing toner to be easily replenished without replacing the developing containers. In the configuration of Japanese Patent Application Laid-open No. 2023-007030, toner is conveyed from the toner cartridges to the developing containers using screws provided inside toner conveying passages.

In Japanese Patent Application Laid-open No. 2023-007030, the toner conveying passages that connect the toner cartridges and the developing units are bent at a plurality of locations to avoid laser light and to connect to toner receiving ports provided at the longitudinal centers of the developing units. As a result, the toner conveying performance may be impaired.

### SUMMARY

The present disclosure is directed to provide a technology capable of improving the conveyance performance of developer from developer containers attachable to and detachable from an apparatus main body to the accommodation portions of the apparatus main body.

In order to solve the above problem, an image forming apparatus according to the present disclosure includes:
an apparatus main body having a plurality of photosensitive drums including a first photosensitive drum, a plurality of developing units aligned in a first direction, and an air supply portion, the plurality of developing units including a first developing unit provided with a first receiving port and having a first developing roller that supplies developer received from the first receiving port to the first photosensitive drum; and
a plurality of developer containers aligned in a second direction orthogonal to the first direction, the plurality of developer containers including a first developer container that accommodates the developer, is provided with a first discharge port, and is attachable to and detachable from the apparatus main body,
wherein the apparatus main body includes
an attachment portion to and from which the plurality of developer containers is attachable and detachable, the attachment portion being provided with a first communication port that is capable of being in communication with the first discharge port, and
a plurality of pipes through which developer conveyed from the plurality of developer containers to the plurality of corresponding developing units passes by air supplied from the air supply portion, the plurality of pipes including a first pipe which extends from the first communication port to the first receiving port and through which the developer discharged from the first discharge port passes, wherein,
in a case where one end surface and the other end surface of the apparatus main body in the second direction are defined as a first end surface and a second end surface, respectively,
the first developer container is provided, in the second direction, at a position closest to the first end surface among the plurality of developer containers,
the first pipe is provided, in the second direction, at a position closest to the first end surface among the plurality of pipes, and
at least a part of the first communication port overlaps the first receiving port in a case of being viewed in the first direction.

Features of the present disclosure will become apparent from the following description of embodiments with reference to the attached drawings. The following description of embodiments is described by way of example.

### BRIEF DESCRIPTION OF THE DRAWINGS

FIG. 1 is a top view of an image forming apparatus according to a first embodiment;

FIG. 2 is a cross-sectional view of the image forming apparatus according to the first embodiment;

FIG. 3A is a perspective view of the image forming apparatus in a state in which a front door is closed;

FIG. 3B is a perspective view of the image forming apparatus in a state in which the front door is opened;

FIG. 3C is a perspective view of the image forming apparatus in which a toner cartridge has been removed from a toner cartridge holder in a state in which the front door is opened;

FIG. 4A is a perspective view of an image forming unit in a state in which each toner cartridge is attached;

FIG. 4B is a perspective view of the image forming unit in a state in which each toner cartridges is detached;

FIG. 5 is a perspective view of the image forming unit according to the first embodiment;

FIG. 6A is a cross-sectional view taken along line A-A of the image forming unit and a laser scanner according to the first embodiment;

FIG. 6B is a cross-sectional view taken along line B-B of the image forming unit and the laser scanner according to the first embodiment;

FIG. 7A is a front view of a toner cartridge;

FIG. 7B is a top view of the toner cartridge;

FIG. 7C is a bottom view of the toner cartridge;

FIG. 7D is a right side view of the toner cartridge;

FIG. 7E is a rear view of the toner cartridge;

FIG. 8A is a cross-sectional view taken along line H-H in FIG. 7E;

FIG. 8B is a cross-sectional perspective view of the toner cartridge;

FIG. 8C is an exploded perspective view of the toner cartridge;

FIG. 9A is a cross-sectional view taken along line G-G in FIG. 7B;

FIG. 9B is a cross-sectional perspective view of FIG. 7A;

FIG. 10 is an explanatory view of an overlapping configuration;

FIG. 11A is a schematic side view of the image forming apparatus and schematically shows only components around a replenishment pipe in an enlarged manner; and

FIG. 11B is a schematic side view of the image forming apparatus and schematically shows only components around a replenishment pipe in an enlarged manner.

### DESCRIPTION OF THE EMBODIMENTS

Hereinafter, with reference to the drawings, modes for implementing the present disclose will be exemplarily described in detail on the basis of embodiments. However, the dimensions, materials, shapes, relative arrangements, and the like of the components described in the embodiments may be appropriately modified in accordance with the configurations and various conditions of apparatuses to which the present disclosure is applied. That is, the scope of the present disclose is not intended to be limited to the following embodiments. Furthermore, although a plurality of features is described in the embodiments, all the features are not necessarily essential to the present disclosure, and they may be combined together arbitrarily. In addition, in the accompanying drawings, the same reference numerals are assigned to the same or similar components, and their redundant descriptions will be omitted.

### First Embodiment

### Image Forming Apparatus

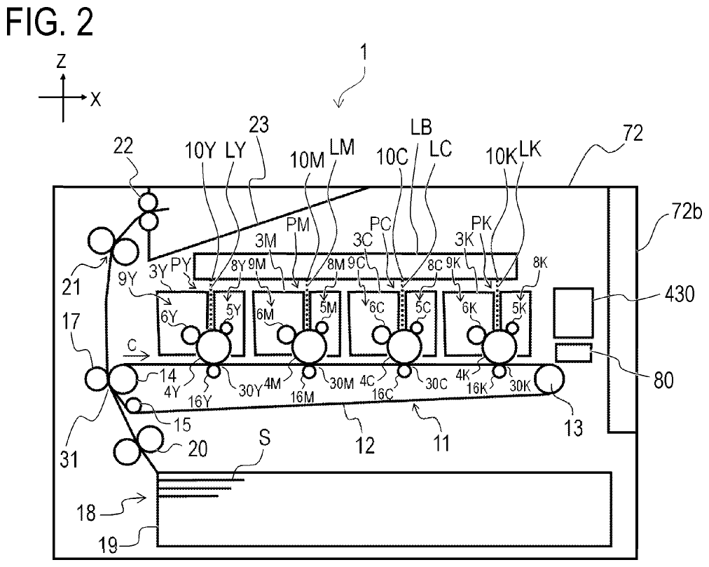

An image forming apparatus 1 according to a first embodiment of the present disclosure will be described below with reference to FIG. 2. The electrophotographic image forming apparatus 1 according to the present embodiment is a full-color image forming apparatus including four-color process cartridges. FIG. 2 is a schematic cross-sectional view showing the schematic configuration of the image forming apparatus 1.

The image forming apparatus 1 is a full-color laser printer employing an electrophotographic process and is capable of forming full-color images on recording media S using four-color toner (developer) (yellow, magenta, cyan, and black). The image forming apparatus 1 includes process cartridges PY, PM, PC, and PK and an apparatus main body 72.

Here, Y, M, C, and K, which are added to the ends of reference numerals assigned to the respective components of the image forming apparatus 1, serve as identifiers for distinguishing the colors (yellow (Y), magenta (M), cyan (C), and black (K)) of the toner corresponding to the components. In the following descriptions, Y, M, C, and K may be omitted except when it is necessary to distinguish the colors from one another.

Each process cartridge P is arranged to be aligned in a direction (first direction) extending substantially along the X direction (horizontal direction intersecting with the axial direction of the photosensitive drum) and accommodates a different color of toner (developer). The longitudinal direction of the process cartridge P (the axial direction of the photosensitive drum) corresponds to the Y direction (second direction), which intersects with the X direction or the first direction.

The image forming apparatus 1 according to the present embodiment is installed and used on a horizontal plane, which is typically assumed to be an installation surface. The X direction and the Y direction shown in each figure are directions, which extend along the horizontal direction and are orthogonal to each other. Furthermore, the Z direction shown in each figure is a direction, which is orthogonal to both the X direction and the Y direction and extends along the vertical direction (gravity direction, height direction, or vertical direction).

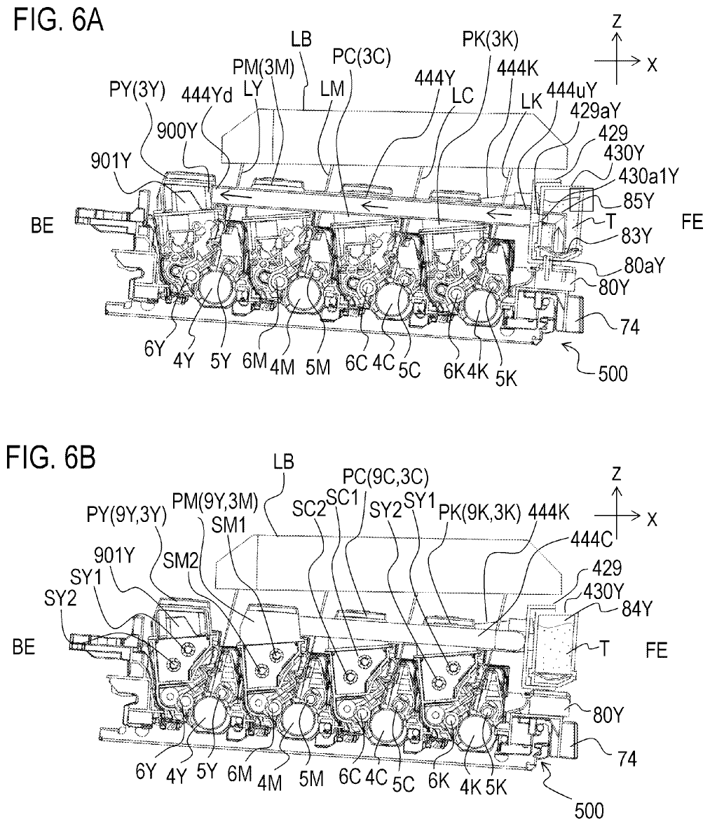

In the present embodiment, each process cartridge P is provided to be aligned in the direction (first direction) extending substantially along the X direction. However, this direction may either coincide with the X direction or be at a slight angle with respect to the X direction. FIG. 2 shows an example of an apparatus configuration in which the first direction coincides with the X direction, and FIGS. 6A and 6B show an example of an apparatus configuration in which the first direction is slightly inclined with respect to the X direction. Both apparatus configurations do not differ from each other in the function or the like of the apparatus, except for the difference between the layouts of the toner replenishment configurations from toner cartridges 430 to the process cartridges P, which will be described later. The present disclosure is applicable to both configurations. In the present embodiment, the first direction, which corresponds to the alignment direction of each process cartridge P, and the second direction, which corresponds to the longitudinal direction of the process cartridges P (the axial direction of the photosensitive drums), are orthogonal to each other. However, a configuration may also be provided in which the first direction and the second direction intersect with each other at a slight angle deviating from orthogonality. That is, the angle formed between the first direction and the second direction is not limited to a right angle (orthogonal) but may be an angle at which they intersect with each other.

Each process cartridge P has an electrophotographic process element. A rotational driving force is transmitted from the driving output portion (not shown) of the apparatus main body 72 to the process cartridge P, and a bias voltage (such as a charging bias and a developing bias) is supplied thereto from the bias applying portion (not shown) of the apparatus main body 72.

As shown in FIG. 2, each process cartridge P includes a drum unit 8Y, 8M, 8C, or 8K. Each drum unit 8 has a photosensitive drum 4Y, 4M, 4C, or 4K, which serves as an image bearing member, and a charging roller 5Y, 5M, 5C, or 5K, which serves as a process unit for acting on its corresponding photosensitive drum 4. Each photosensitive drum 4 is arranged such that the direction of its rotational axis extends along the Y direction. That is, each photosensitive drum 4 is rotatable about the rotational axis that extends in the Y direction (second direction). Each process cartridge P includes a developing unit 9Y, 9M, 9C, or 9K having a developing roller 6Y, 6M, 6C or 6K, which serves as a developer supplying member for developing electrostatic latent images on its corresponding photosensitive drum 4. Each developing unit 9 is aligned to extend along the X direction.

The developing unit 9Y has a developing container 3Y, which serves as a main body accommodation portion for accommodating yellow (Y) toner, and the developing roller 6Y, which serves as a developer bearing member for bearing the yellow (Y) toner. The yellow (Y) toner is supplied to the surface of the photosensitive drum 4Y by the developing roller 6Y. The developing unit 9M has a developing container 3M, which serves as a main body accommodation portion for accommodating magenta (M) toner, and the developing roller 6M, which serves as a developer bearing member for bearing the magenta (M) toner. The magenta (M) toner is supplied to the surface of the photosensitive drum 4M by the developing roller 6M. The developing unit 9C has a developing container 3C, which serves as a main body accommodation portion for accommodating cyan (C) toner, and the developing roller 6C, which serves as a developer bearing member for bearing the cyan (C) toner. The cyan (C) toner is supplied to the surface of the photosensitive drum 4C by the developing roller 6C. The developing unit 9K has a developing container 3K, which serves as a main body accommodation portion for accommodating black (K) toner, and the developing roller 6K, which serves as a developer bearing member for bearing the black (K) toner. The black (K) toner is supplied to the surface of the photosensitive drum 4K by the developing roller 6K.

In the Z direction (third direction), which intersects with both the X direction (first direction) and the Y direction (second direction), a laser scanner unit LB (exposure unit), which serves as an exposure portion, is provided above the process cartridges P (photosensitive drums 4). The laser scanner unit LB outputs laser light corresponding to image information and irradiates each photosensitive drum 4 with the laser light. Hereinafter, the light paths of the laser light directed toward the photosensitive drums 4Y, 4M, 4C, and 4K will be referred to as light paths LY, LM, LC, and LK, respectively. Then, the laser light passes through exposure windows 10Y, 10M, 10C, and 10K of the laser scanner unit LB and scans and exposes the surface of each photosensitive drum 4. Note that an LED exposure unit may be used as the exposure portion instead of the laser scanner unit LB.

An intermediate transfer belt unit 11, which serves as a transfer member, is provided below the process cartridges P in the Z direction. The intermediate transfer belt unit 11 has a driving roller 14, a tension roller 13, and an assist roller 15, and a transfer belt 12 having flexibility is stretched over between these rollers. Each photosensitive drum 4 has a peripheral surface, the lower end region of which is in contact with the upward-facing region of the peripheral surface of the transfer belt 12. The contact portions between the respective photosensitive drums 4 and the transfer belt 12 are primary transfer portions 30Y, 30M, 30C and 30K. Primary transfer rollers 16Y, 16M, 16C, and 16K are provided at positions corresponding to the photosensitive drums 4Y, 4M, 4C, and 4K, with the transfer belt 12 interposed therebetween on the inner side of the transfer belt 12. A secondary transfer roller 17 is pressed against the driving roller 14 via the transfer belt 12. The contact portion between the transfer belt 12 and the secondary transfer roller 17 is a secondary transfer portion 31.

A sheet feeding unit 18 is provided below the intermediate transfer belt unit 11 in the Z direction. The sheet feeding unit 18 has a sheet feeding tray 19, which loads and accommodates recording media (recording materials) S such as recording papers and sheets, and a sheet feeding roller 20, which picks up and conveys the recording media S from the sheet feeding tray 19. In the upper portion of the apparatus main body 72 in FIG. 2, there are provided a fixing unit 21, which fixes toner images onto the recording media S, and a discharging roller 22, which discharges the recording media S, onto which the toner images have been fixed, to an output tray 23. The discharging roller 22 discharges the recording media S in a direction extending along the X direction. Note that in the present embodiment, the downstream side in the discharging direction, in which the recording media S are discharged toward the output tray 23 by the discharging roller 22, is assumed as the front side of the image forming apparatus 1, while the upstream side in the discharging direction is assumed as the rear side of the image forming apparatus 1.

### Image Forming Operation

The image forming operation for forming full-color images is as follows. Each photosensitive drum 4 is driven to rotate in the counterclockwise direction at a specified speed as shown in FIG. 2. The transfer belt 12 is driven to rotate in the forward direction of each photosensitive drum 4 (as indicated by arrow C in FIG. 2) at a speed corresponding to the rotational speed of each photosensitive drum 4. The laser scanner unit LB is also driven. In synchronization with the driving of the laser scanner unit LB, each charging roller 5 in each process cartridge P uniformly charges the surface of each photosensitive drum 4 with a specified polarity and at a specified potential. The laser scanner unit LB scans and exposes the charged surface of each photosensitive drum 4 with laser light in accordance with the image signal for each color. As a result, an electrostatic latent image corresponding to the image signal for each color is formed on the surface of each photosensitive drum 4. The electrostatic latent image on each photosensitive drum 4 is developed by supplying toner to each photosensitive drum 4 through each developing roller 6 that is driven to rotate in the clockwise direction at a specified speed as shown in FIG. 2.

Through the electrophotographic image forming process described above, a yellow toner image is formed on the photosensitive drum 4Y of the process cartridge PY. Then, the yellow toner image is primarily transferred onto the transfer belt 12. Similarly, a magenta toner image is formed on the photosensitive drum 4M of the process cartridge PM. Then, the magenta toner image is primarily transferred onto the transfer belt 12 so as to be superimposed on the yellow toner image on the transfer belt 12. A cyan toner image is formed on the photosensitive drum 4C of the process cartridge PC. Then, the cyan toner image is primarily transferred onto the transfer belt 12 so as to be superimposed on the yellow and magenta toner images on the transfer belt 12. A black toner image is formed on the photosensitive drum 4K of the process cartridge PK. Then, the black toner image is primarily transferred onto the transfer belt 12 so as to be superimposed on the yellow, magenta, and cyan toner images on the transfer belt 12.

In this manner, an unfixed full-color toner image composed of the four colors of yellow, magenta, cyan, and black is formed on the transfer belt 12. Meanwhile, the recording media S are individually separated from the sheet feeding tray 19 by the sheet feeding roller 20 and fed at a specified control timing. The recording media S are then guided into the secondary transfer portion 31, which is the contact portion between the secondary transfer roller 17 and the transfer belt 12, at a specified control timing. As the recording media S are conveyed through the secondary transfer portion 31, the toner image composed of the four superimposed colors is transferred from the transfer belt 12 onto the recording media S. The recording media S, onto which the toner image has been transferred, are heated and pressurized by the fixing unit 21, thereby fixing the toner image onto the recording media S. The recording media S, onto which the toner image has been fixed, is discharged to the output tray 23 by the discharging roller 22.

### Description of Toner Cartridges

The image forming apparatus 1 has toner cartridges 430Y, 430M, 430C, and 430K (hereinafter referred to as each toner cartridge 430), which serve as developer containers that are attachable to and detachable from the apparatus main body 72. Each toner cartridge 430 is aligned in the Y direction (second direction) at a position corresponding to where each developing unit 9 is aligned in substantially the X direction (first direction). That is, each toner cartridge 430 is aligned in a direction intersecting with (is orthogonal to) the direction in which each developing unit 9 is aligned.

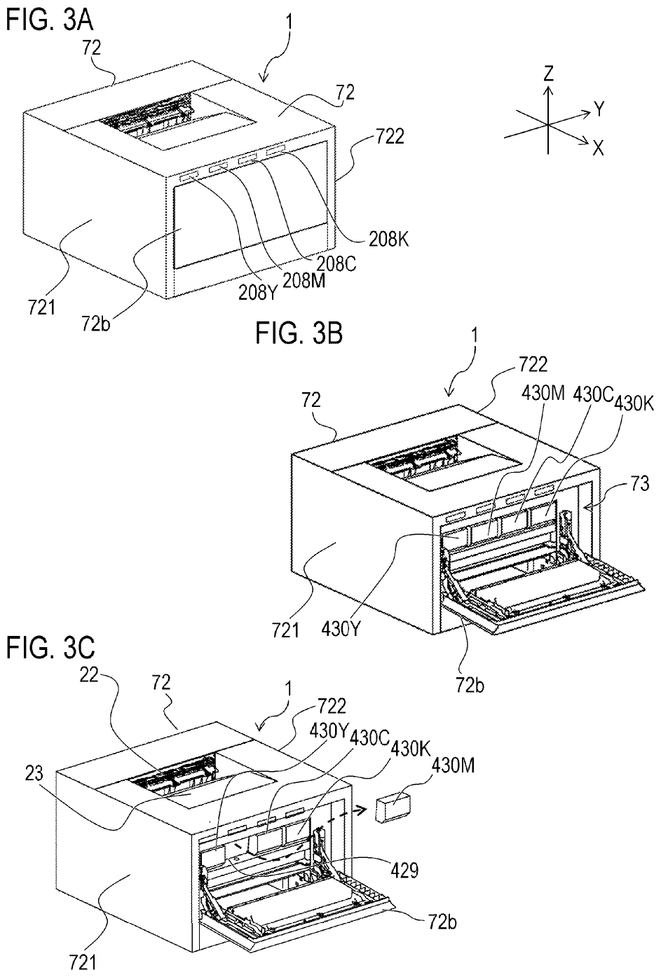

FIG. 3A is a perspective view of the image forming apparatus 1 in a state in which a front door 72b, which serves as an opening/closing member, is closed. FIG. 3B is a perspective view of the image forming apparatus 1 in a state in which the front door 72b is opened. FIG. 3C is a perspective view of the image forming apparatus 1 in which the toner cartridge 430M has been removed from a toner cartridge holder 429 in a state in which the front door 72b is opened.

Each toner cartridge 430 is attached to the upper side at the front of the apparatus main body 72 and exposed to the outside through an opening portion 73 formed on the front side of the apparatus main body 72 when the front door 72b is opened, allowing a user to access each toner cartridge 430. In other words, each toner cartridge 430 is provided at the downstream end of the apparatus main body 72 in the discharging direction of the recording media S discharged by the discharging roller 22. The front door 72b is configured to be movable between a closed position (see FIG. 3A) in which the apparatus main body 72 is closed and an open position (see FIG. 3B) in which the apparatus main body 72 is opened on the front side. When the front door 72b is moved to the open position, each toner cartridge 430 is exposed to the outside of the image forming apparatus 1 as shown in FIG. 3B. Each toner cartridge 430 is arranged side by side in the Y direction (second direction) and configured to be attachable to and detachable from the apparatus main body 72 in the X direction (first direction) as shown in FIG. 3C. As a result, the toner cartridge 430 is replaced without detaching each process cartridge P from the apparatus main body 72, allowing continuous replenishment of toner into each process cartridge P. Since each toner cartridge 430 is arranged on the front side of the image forming apparatus 1, access to each toner cartridge 430 is possible from the front side, like the collection of the recording media S discharged onto the output tray 23. Furthermore, since the toner cartridge holder 429 is provided on the front side of the image forming apparatus 1 as an attachment portion, each process cartridge P is configured to remain unexposed even after each toner cartridge 430 is removed (see FIG. 3C). Each toner cartridge 430 is accommodated inside the apparatus main body 72 in a state in which the front door 72b is closed.

As shown in FIG. 3A, indicators (display portions) 208Y, 208M, 208C, and 208K corresponding to the respective colors are provided on the front side of the image forming apparatus 1. The indicators 208 are arranged side by side in the Y direction (second direction) so as to correspond to the respective toner cartridges 430. The indicator 208Y is yellow, the indicator 208M is magenta, the indicator 208C is cyan, and the indicator 208K is black. Each indicator 208 is composed of an LED or a seal of a color corresponding to the toner color in each cartridge and provided to prevent the erroneous attachment of each toner cartridge 430. Furthermore, each indicator 208 may have the function of indicating the remaining toner amount in the corresponding process cartridge P (each developing unit 9).

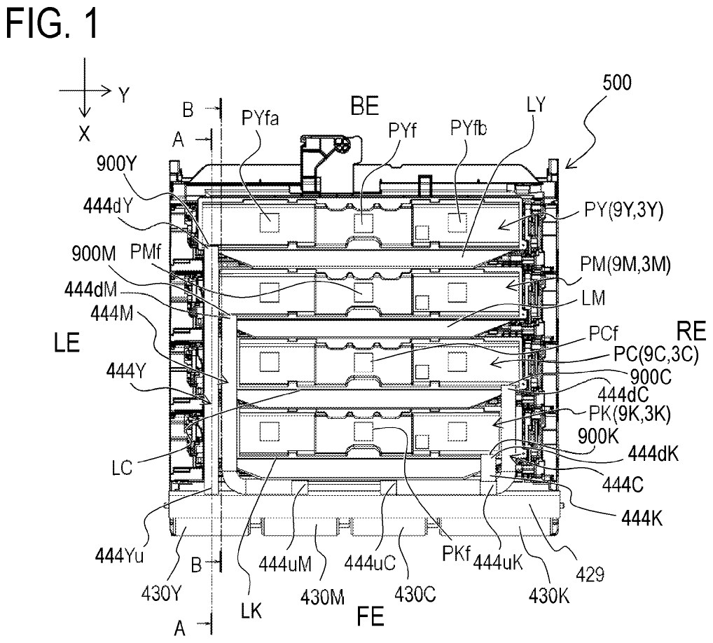

With reference to FIG. 1 and FIGS. 4A to 6B, the toner conveying mechanism of each toner cartridge 430 will be described. The unit that includes each toner cartridge 430, each process cartridge P, and a cartridge tray 74 (drawing member) that supports these components is defined as an image forming unit 500. The image forming unit 500 also includes conveying passages that convey toner from each toner cartridge 430 to each process cartridge P, which will be described later.

In the present embodiment, the four process cartridges PY, PM, PC, and PK are each mounted on the cartridge tray 74 and configured to be movable integrally with the cartridge tray 74 with respect to the apparatus main body 72. The cartridge tray 74 is configured to be movable between a mounting position inside the apparatus main body 72 and a drawn-out position outside the apparatus main body 72 through the opening portion 73 of the apparatus main body 72, which is formed when the front door 72b is opened. The mounting position is a position where each process cartridge P is located in a specified mounting position in the apparatus main body 72. The drawn-out position is a position where each process cartridge P is located outside the apparatus main body 72, allowing the replacement of each process cartridge P.

Furthermore, in the present embodiment, each toner cartridge 430 and the conveying mechanisms that convey toner from the toner cartridges 430 to the process cartridges P are also integrally mounted on the cartridge tray 74. That is, the toner cartridges 430 and the toner conveying mechanisms are also configured to move in and out of the apparatus main body 72 together with the movement of the cartridge tray 74. That is, the toner cartridges 430 are attachable to and detachable from the apparatus main body 72 not only when the cartridge tray 74 is in the mounting position as shown in FIG. 3C, but also when the cartridge tray 74 is drawn out to the drawn-out position. Note that the configuration of the process cartridges P is not limited to this configuration. At least a part of the process cartridges P may be configured to be fixed to the apparatus main body 72 or the cartridge tray 74. Furthermore, the process cartridges P may be configured to be attachable to and detachable from the apparatus main body 72 in a direction different from the attachment and detachment direction of the toner cartridges 430. Furthermore, a configuration may also be employed in which the toner cartridges 430 and the toner conveying mechanisms are provided on the apparatus main body 72 instead of on the cartridge tray 74.

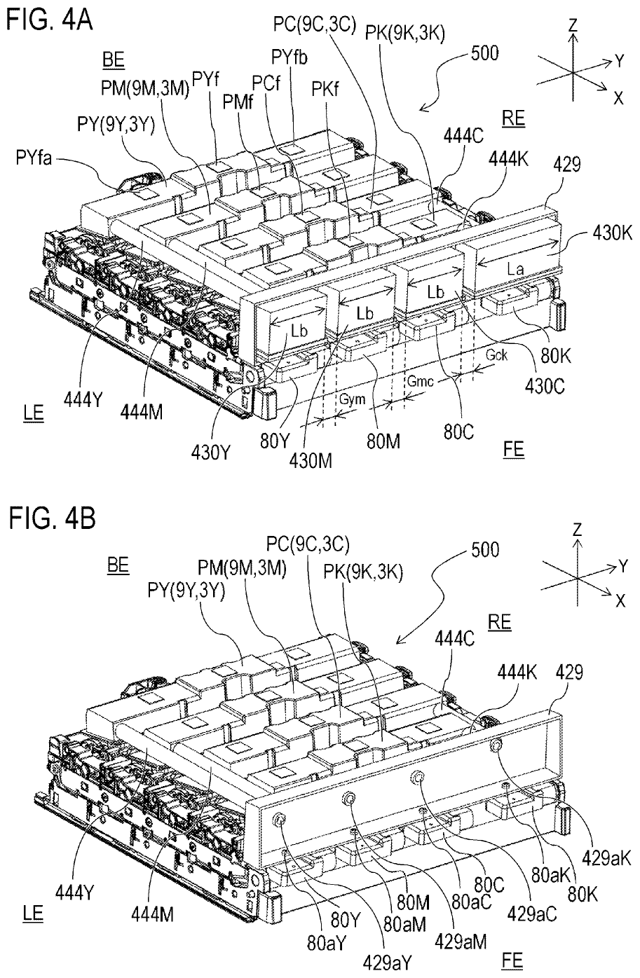

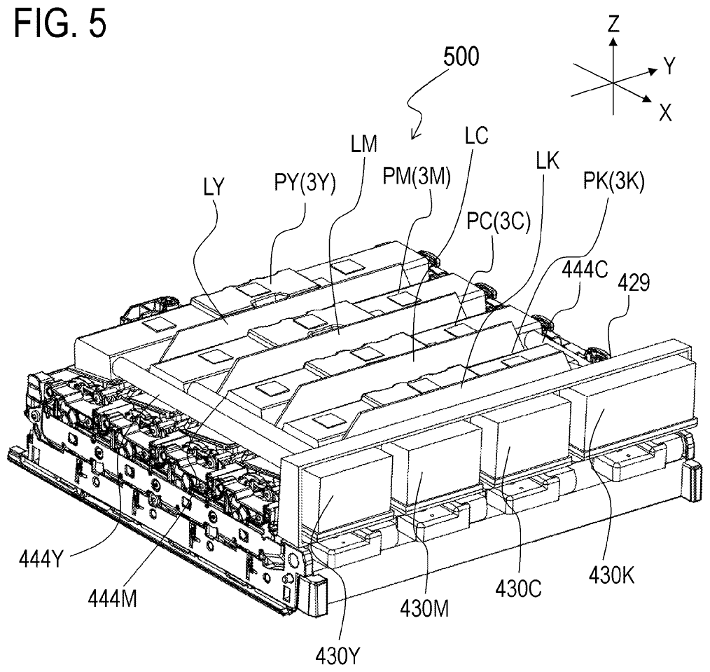

FIG. 1 is a top view of the image forming unit 500. FIG. 4A is a perspective view of the image forming unit 500 in a state in which each toner cartridge 430 is attached. FIG. 4B is a perspective view of the image forming unit 500 in a state in which each toner cartridges 430 is detached. FIG. 5 is a perspective view showing the light paths of the laser light emitted from the laser scanner unit LB with respect to the image forming unit 500. FIGS. 6A and 6B are cross-sectional views taken along line A-A and line B-B in FIG. 1, respectively.

As shown in FIGS. 4A and 5, the cartridge tray 74 is provided with the toner cartridge holder 429 and pump units 80Y, 80M, 80C, and 80K, which serve as air supply portions for supplying compressed air into the interior of the toner cartridges 430. The pump units 80 are arranged below the toner cartridge holder 429. Each pump unit 80 is aligned in the Y direction (second direction). The pump units 80 may be implemented using positive displacement pumps such as reciprocating pumps or rotary pumps. The reciprocating pumps perform suction and ejection through the reciprocating motion of a piston, a plunger, or the like, and examples of the reciprocating pumps include piston pumps, plunger pumps, diaphragm pumps, and the like. The rotary pumps perform suction and ejection through the rotational movement of gears and rotors, and examples of the rotary pumps include gear pumps, screw pumps, vane pumps, and the like. Note that four pump units 80 may be provided corresponding to the four toner cartridges 430, or a single pump unit 80 may supply compressed air to the four toner cartridges 430. In the present embodiment, each pump unit 80 is provided as a component on the side of the apparatus main body 72. However, it may also be provided in each toner cartridge 430.

Each pump unit 80 is provided with an ejection port 80aY, 80aM, 80aC, or 80aK through which the generated compressed air is ejected. In the parts of the toner cartridge holder 429 that face the lower surfaces of the toner cartridges 430, openings are provided where the ejection ports 80a of the pump units 80 are exposed, as shown in FIGS. 4B and 6A. Each ejection port 80a is open upward. The compressed air discharged upward from each ejection port 80a is supplied to the inside of each toner cartridge 430 attached to the toner cartridge holder 429. The compressed air supplied to the inside of each toner cartridge 430 is discharged to the outside together with toner from the toner cartridge 430.

### Configurations of Toner Cartridges

With reference to FIG. 4A and FIGS. 7A to 9B, the configurations of the toner cartridges (toner containers) 430 according to the present embodiment will be described.

As shown in FIG. 4A, the width La of the toner cartridge 430K is wider than the width Lb of the toner cartridges 430Y, 430M, and 430C in the Y direction. Accordingly, the volume of the toner cartridge 430K that is capable of accommodating toner is greater than those of the toner cartridges 430Y to 430C. By allowing the accommodation of more black toner, which is typically consumed in greater amounts than other toner, the number of replacement cycles for the toner cartridges 430Y, 430M, 430C, and 430K is easily equalized. Except for the width in the Y direction, the configurations of the toner cartridges 430 are the same. Therefore, the configuration of the toner cartridge 430Y will be described here, and the descriptions of the configurations of the toner cartridges 430M, 430C, and 430K will be omitted.

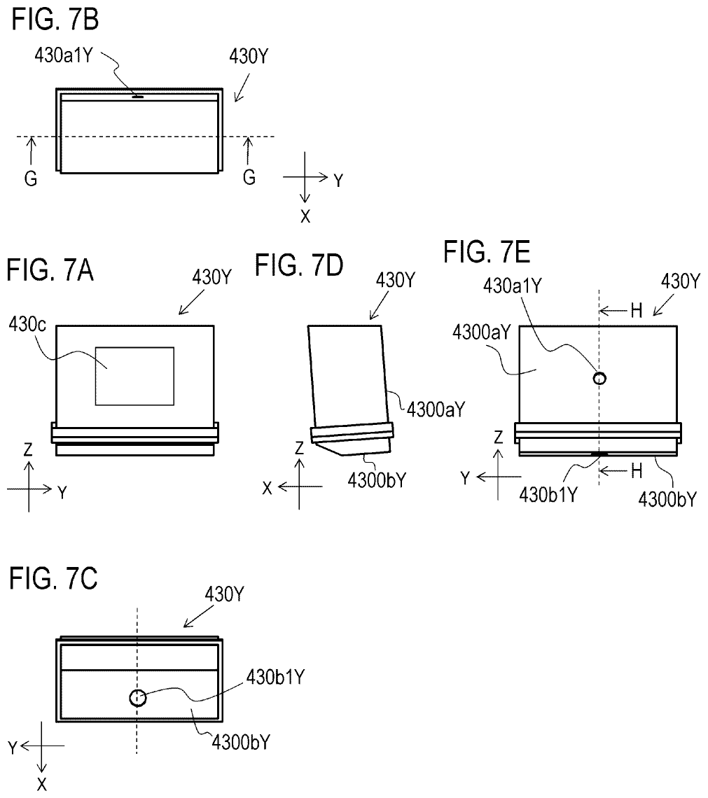

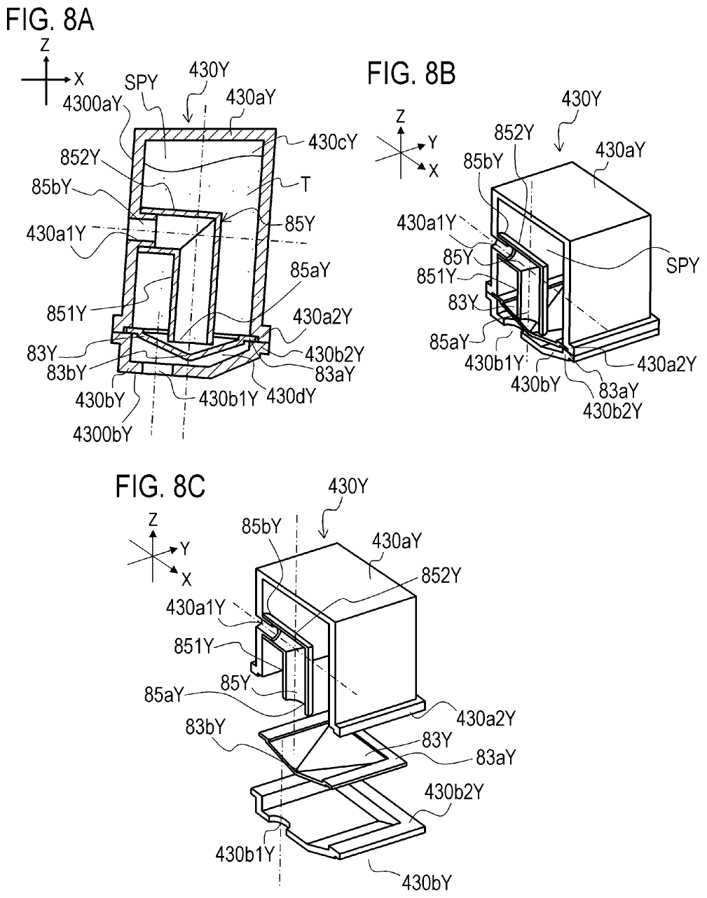

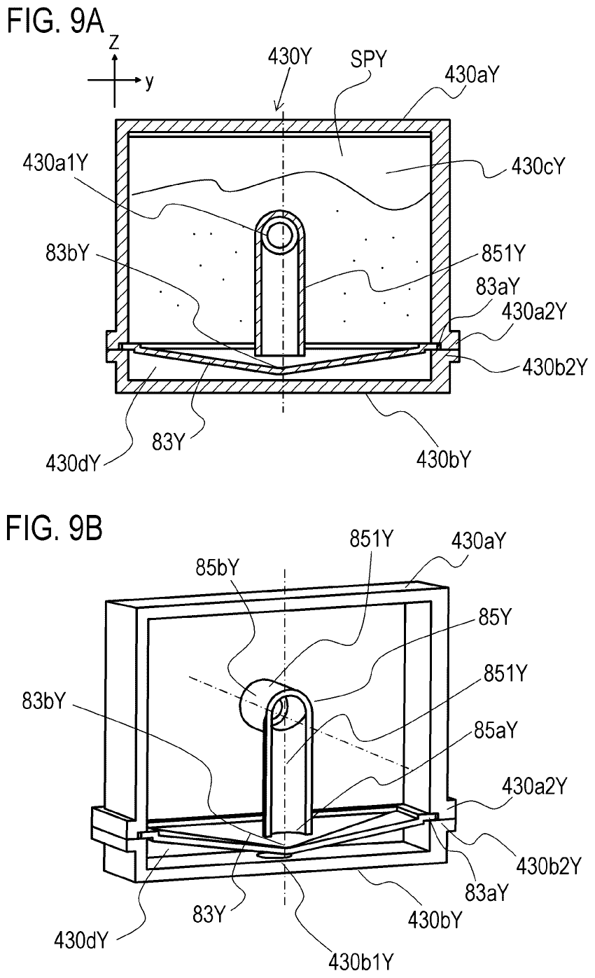

FIGS. 7A, 7B, 7C, 7D, and 7E are front, top, bottom, right side, and rear views of the toner cartridge 430Y, respectively. FIG. 8A is a cross-sectional view taken along line H-H in FIG. 7E. FIG. 8B is a cross-sectional perspective view of the toner cartridge 430Y. FIG. 8C is an exploded perspective view of the toner cartridge 430Y. FIG. 9A is a cross-sectional view taken along line G-G in FIG. 7B. FIG. 9B is a cross-sectional perspective view of FIG. 7A. Note that the following description of the configuration of the toner cartridge 430Y assumes that the toner cartridge 430Y has been attached (oriented) to the toner cartridge holder 429.

As shown in FIGS. 8A and 8B, the toner cartridge 430Y has a first frame body 430aY, a second frame body 430bY, a filter 83Y (ventilation member), and a discharge pipe 85Y. Although not shown, the toner cartridge 430M also similarly has a first frame body 430aM, a second frame body 430bM, a filter 83M (ventilation member), and a discharge pipe 85M. Similarly, the toner cartridge 430C also has a first frame body 430aC, a second frame body 430bC, a filter 83C (ventilation member), and a discharge pipe 85C. Similarly, the toner cartridge 430K also has a first frame body 430aK, a second frame body 430bK, a filter 83K, and a discharge pipe 85K.

Although the first frame body 430aY and the second frame body 430bY of the toner cartridge 430Y according to the present embodiment are resin-molded members, they may be made of paper or the like. As shown in FIG. 7E, a discharge port 430a1Y (developer discharge port) for discharging toner is provided on a rear surface 4300aY of the first frame body 430aY. As shown in FIG. 7C, a receiving port 430b1Y (air receiving port) for receiving the compressed air to convey the toner is provided on a bottom surface 4300bY of the second frame body 430bY.

The discharge port 430a1Y and the receiving port 430b1Y may be provided on a surface of the toner cartridge 430Y other than a surface (a surface facing the Y direction) that intersects with the Y direction (second direction) in which each toner cartridge 430 is aligned. This allows the gaps G (Gym, Gmc, and Gck) between the toner cartridges 430 shown in FIG. 4A to be reduced. As a result, the width L of each toner cartridge 430 is widened, allowing an increase in their volume to accommodate toner. Note that the gap Gym is the gap between the toner cartridge 430Y and the toner cartridge 430M in the Y direction (second direction). The gap Gmc is the gap between the toner cartridge 430M and the toner cartridge 430C in the Y direction (second direction). The gap Gck is the gap between the toner cartridge 430C and the toner cartridge 430K in the Y direction (second direction).

Furthermore, the discharge port 430a1Y is provided on the rear surface 4300aY of the toner cartridge 430Y (i.e., the end surface of the toner cartridge 430Y on the downstream side in the attachment direction) so as to be open toward the downstream side in the attachment direction (the direction extending substantially along the −X direction). Accordingly, when the toner cartridge 430Y is attached to the toner cartridge holder 429, the discharge port 430a1Y is easily engaged so as to be in communication with a receiving port 429aY (communication port) of the toner cartridge holder 429. Note that the discharge port 430a1Y may be provided on the bottom surface 4300bY or the upper surface of the toner cartridge 430Y, and the receiving port 430b1Y may be provided on the rear surface 4300aY or the upper surface of the toner cartridge 430Y. If there is sufficient space within the apparatus main body 72, the discharge port 430a1Y and the receiving port 430b1Y may be provided on the surface that intersects with the Y direction (second direction). Furthermore, although not shown, the toner cartridge 430M has a discharge port 430a1M and a receiving port 430b1M that are arranged in the same manner as the toner cartridge 430Y. The toner cartridge 430C has a discharge port 430a1C and a receiving port 430b1C, which are arranged in the same manner as those of the toner cartridge 430Y. The toner cartridge 430K has a discharge port 430a1K and a receiving port 430b1K, which are arranged in the same manner as those of the toner cartridge 430Y.

The discharge port 430a1Y may be provided with a sealing member (seal or shutter) not shown. In a state in which the toner cartridge 430Y is not mounted on the toner cartridge holder 429, the sealing member seals the discharge port 430a1Y to suppress the leakage of toner T from inside the toner cartridge 430Y to the outside of the toner cartridge 430Y. When the toner cartridge 430Y is mounted on the toner cartridge holder 429, the sealing member is removed or moved so that the discharge port 430a1Y is open.

A front label 430c of the toner cartridge 430Y shown in FIG. 7A is intended to display the color of the internal toner. Furthermore, the label 430c may display an instruction illustrating a method for mounting the toner cartridge 430Y on the toner cartridge holder 429, or may display any information on the toner cartridge 430Y.

The first frame body 430aY has a flange portion 430a2Y, and the second frame body 430bY has a flange portion 430b2Y. By welding the flange portion 430a2Y and the flange portion 430b2Y to each other through ultrasonic welding, an internal space SPY of the toner cartridge 430Y shown in FIG. 8A is formed. Note that the flange portion 430a2Y and the flange portion 430b2Y may be fixed to each other through an adhesive or screws.

The filter 83Y is provided to partition (divide or separate) the internal space SPY of the toner cartridge 430Y into two spaces, i.e., a toner chamber 430cY (developer accommodation chamber) and an air chamber 430dY. That is, the air chamber 430dY is adjacent to the toner chamber 430Yc via the filter 83Y. Although not shown, a filter 83M of the magenta toner cartridge 430M is provided to partition the internal space SPM of the toner cartridge 430M into a toner chamber 430cM and an air chamber 430dM. That is, the air chamber 430dM is adjacent to the toner chamber 430cM via the filter 83M. A filter 83C of the cyan toner cartridge 430C is provided to partition the internal space SPC of the toner cartridge 430C into a toner chamber 430cC and an air chamber 430dC. That is, the air chamber 430dC is adjacent to the toner chamber 430cC via the filter 83C. A filter 83K of the black toner cartridge 430K is provided to partition the internal space SPK of the toner cartridge 430K into a toner chamber 430cK and an air chamber 430dK. That is, the air chamber 430dK is adjacent to the toner chamber 430cK via the filter 83K.

The toner chamber 430cY is located above the air chamber 430dY and aligned with the air chamber 430dY in the Z direction (third direction). That is, the orientation in which the toner cartridge 430cY is directed to be above the air chamber 430dY corresponds to the mounting posture of the toner cartridge 430Y with respect to the apparatus main body 72. The third direction (Z direction), which is the alignment direction of the toner chamber 430cY and the air chamber 430dY, is a direction that intersects with (is orthogonal to) both the first direction (X direction), which is the alignment direction of the process cartridges P, and the second direction, which is the alignment direction (Y direction) of the toner cartridges 430. Accordingly, in the present embodiment, the receiving port 430b1Y is open toward this alignment direction, and the discharge port 430a1Y is open in a direction intersecting with this alignment direction.

The filter 83Y is configured to allow the passage of air and prevent the passage of toner, and the toner T is accommodated only in the toner chamber 430cY inside the toner cartridge 430Y. The filter 83Y is provided to vertically partition the toner chamber 430cY and the air chamber 430dY, and the toner T is supported by the filter 83Y in the toner chamber 430cY. That is, the filter 83Y constitutes the bottom portion of the toner chamber 430cY. The receiving port 430b1Y is provided so as to be in communication with the air chamber 430dY, and the compressed air supplied from the pump unit 80Y is introduced into the air chamber 430dY via the receiving port 430b1Y.

No toner is accommodated in the air chamber 430dY. The filter 83Y is composed of a porous member made of, for example, resin fibers and has a pore size and density that allow the passage of air and suppress the passage of toner. That is, the filter 83Y is configured to allow the passage of air and suppress the passage of toner.

As shown in FIGS. 8A to 9C, the filter 83Y has an outer edge portion 83aY that is sandwiched between a flange portion 430a2Y of the first frame body 430aY and a flange portion 430b2Y of the second frame body 430bY and held between the first frame body 430aY and the second frame body 430bY. Furthermore, the filter 83Y has a recessed shape in which the region on the inner side of the outer edge portion 83aY is recessed such that the central portion of the filter 83Y is the lowest. That is, the filter 83Y has a lowest portion 83bY, which protrudes in a direction (third direction) from the toner chamber 430cY toward the air chamber 430dY with respect to the outer edge portion 83aY. The lowest portion 83bY of such a recessed shape is located below the outer edge portion 83aY, and the surface of the filter 83Y that faces the toner chamber 430cY is an inclined surface, which slopes downward in a substantially conical shape from the outer edge portion 83aY toward the lowest portion 83bY. That is, the surface of the filter 83Y that faces the toner chamber 430cY has a sloped shape (inclined portion) that descends (as it approaches) from the outer edge portion 83aY toward the lowest portion 83Yb in the X direction (first direction), the Y direction (second direction), or the horizontal direction. In the present embodiment, the filter 83Y molded into the above-described shape is used.

The toner chamber 430cY is provided with the discharge pipe 85Y (passage). Although the discharge pipe 85Y according to the present embodiment is a resin-molded member, it may be made of paper, rubber, or the like. The discharge pipe 85Y has an inlet 85aY (first opening) and an outlet 85bY (second opening) and extends from the inlet 85aY to the outlet 85bY. The outlet 85bY of the discharge pipe 85Y is connected to the discharge port 430a1Y of the toner chamber 430cY. That is, the discharge port 430a1Y of the toner chamber 430cY is configured so as to be in communication with the interior of the toner chamber 430cY via the discharge pipe 85Y that extends through the toner chamber 430cY.

The discharge pipe 85Y is a passage through which the toner T accommodated in the toner chamber 430cY passes when being moved toward the discharge port 430a1Y. The discharge pipe 85Y has a first portion 851Y, which is provided with the inlet 85aY and extends in the third direction (Z direction), and a second portion 852Y, which is provided with the outlet 85bY and extends in the first direction (X direction). The direction in which the first portion 851Y extends and the direction in which the second portion 852Y extends intersect with each other (are orthogonal to each other). The outlet 85bY of the discharge pipe 85Y is connected so as to be in communication with the discharge port 430a1Y. The inlet 85aY of the discharge pipe 85Y is arranged so as to face the lowest portion 83bY, which is a part of the filter 83Y, with a gap therebetween. In other words, the filter 83Y has a recessed shape such that the lowest portion 83bY is located at a position corresponding to the inlet 85aY of the discharge pipe 85Y. The inlet 85aY of the discharge pipe 85Y may be disposed in proximity to the filter 83Y. When the remaining amount of the toner T in the toner chamber 430cY becomes small, the toner T fluidized by the compressed air received from the receiving port 430b1Y moves along the inclination of the filter 83Y described above and accumulates at the lowest portion 83bY. The inlet 85aY of the discharge pipe 85Y allows the toner T accumulated at the lowest portion 83bY of the filter 83Y to be guided to the discharge port 430a1Y. As a result, even when the remaining amount of the toner accommodated in the toner chamber 430cY of the toner cartridge 430Y becomes small, it is possible to efficiently discharge the toner T to the outside of the toner cartridge 430Y.

The toner cartridges 430 according to the present embodiment have a configuration in which the compressed air discharges the toner to the outside of the toner cartridges 430, eliminating the need to provide rotating members such as screws. Accordingly, it is possible to provide cartridges having a simple configuration with a reduced number of components.

### Toner Conveying Mechanism

A mechanism will be described in which the toner accommodated in the toner chamber 430cY of the toner cartridge 430Y is conveyed to the developing unit 9Y. As shown in FIG. 8A, the compressed air ejected upward from the ejection port 80aY of the pump unit 80Y is received by the air chamber 430dY via the receiving port 430b1Y of the toner cartridge 430Y. Then, the compressed air increases the air pressure inside the air chamber 430dY, passes through the filter 83Y, and flows into the toner chamber 430cY. The compressed air flowing into the toner chamber 430cY enters between the particles of the toner T to fluidize the toner T. The toner T, which is mixed with the compressed air and fluidized, flows into the discharge pipe 85Y from the inlet 85aY by means of the compressed air that has further flowed into the air chamber 430dY via the inlet 430b1Y. The toner T flowing into the discharge pipe 85Y is moved to the outlet 85bY through the discharge pipe 85Y and discharged from the discharge port 430a1Y to the outside of the toner cartridge 430Y.

As in the present embodiment, by providing the air chamber 430dY, which is a highly hermetic space, between the ejection port 80aY and the filter 83Y, the compressed air ejected from the ejection port 80aY is efficiently directed toward the filter 83Y without being dispersed outside the toner cartridge 430Y. For example, if the toner cartridge 430Y is subjected to vibration or left unused for a long time, the toner T in the toner chamber 430cY may aggregate. In such a situation, a higher pressure may be required to cause the compressed air to pass through the filter 83Y and flow into the toner chamber 430cY. Even in this case, it is possible to feed the compressed air into the toner chamber 430cY through the filter 83Y by continuously feeding the compressed air from the pump unit 80Y to the air chamber 430dY and increasing the pressure (atmospheric pressure) inside the air chamber 430dY. Furthermore, by providing the air chamber 430dY, it is sufficient for the performance of the pump unit 80Y to allow the continuous feeding of the compressed air such that the pressure inside the air chamber 430dY increases to a level sufficient to cause the compressed air to pass from the filter 83Y into the toner chamber 430cY. Accordingly, since no specific requirement is imposed on the ejection speed or ejection amount of the pump unit 80Y, the employment of a small pump unit becomes possible, contributing to the size reduction of the apparatus.

As shown in FIGS. 6A and 8A, the toner T discharged from the discharge port 430a1Y of the toner cartridge 430Y enters a replenishment pipe 444Y from an upstream end 444uY via the inlet 429aY of the toner cartridge holder 429. The toner T that has entered the replenishment pipe 444Y from the upstream end 444uY is moved to a downstream end 444dY by means of the compressed air that has flowed into the upstream end 444uY together with the toner T, and is replenished into the developing unit 9Y (developing container 3Y) of the process cartridge PY.

The toner replenished into the developing unit 9Y (developing container 3Y) from the end of the developing unit 9Y in the Y direction (second direction) is stirred and leveled inside the toner accommodation chamber of the developing unit 9Y (developing container 3Y) by stirring members SY1 and SY2 shown in FIG. 6B. The stirring members SY1 and SY2 may be, for example, screws that extend in the Y direction (second direction). That is, the stirring members SY1 and SY2 only need to be capable of conveying the toner from an end (first end) of the developing unit 9Y, to which the downstream end 444dY of the replenishment pipe 444Y is connected, to an end (second end) of the developing unit 9Y on the opposite side.

Since not only the toner T but also the compressed air flows into the developing unit 9Y (developing container 3Y) from the replenishment pipe 444Y, the internal pressure inside the developing unit 9Y tends to increase. Therefore, in the present embodiment, a discharge filter portion PfY is provided on the upper surface of the developing unit 9Y as shown in FIGS. 4A and 4B. The discharge filter portion PfY is formed by providing a through hole in a frame body that forms the developing unit 9Y and disposing a filter such as a non-woven fabric in the through hole. The toner T that has flowed into the developing unit 9Y from the replenishment pipe 444Y remains in the developing unit 9Y, and at least some of the compressed air is discharged from the discharge filter portion PfY to the outside of the developing unit 9Y. As a result, an increase in the internal pressure of the developing unit 9Y is suppressed, and the toner T and the compressed air tend to flow more easily into the developing unit 9Y from the toner cartridge 430Y through the replenishment pipe 444Y.

In the present embodiment, the discharge filter portion PfY is provided at the central portion of the developing unit 9Y in the Y direction (second direction). Like a discharge filter PfaY, the discharge filter portion PfY may also be provided at the end of the developing container 3Y in the Y direction (second direction) on the side where the downstream end 444dY of the replenishment pipe 444Y is located. Furthermore, like a discharge filter PfbY, the discharge filter portion PfY may also be provided at the opposite end of the developing unit 9Y in the Y direction (second direction), that is, at the end of the developing unit 9Y on the side opposite to the side where the downstream end 444dY of the replenishment pipe 444Y is located. Furthermore, the discharge filter PfbY may also be provided not on the upper surface of the developing unit 9Y but on the side surface of the developing unit 9Y.

### Configurations of Replenishment Pipes

With reference to FIGS. 1, 5, and 6A, the configurations of the replenishment pipes will be described. As described above, the toner discharged from each toner cartridge 430 together with the compressed air is received by each replenishment pipe 444 via each receiving port 429a provided in the toner cartridge holder 429. Each replenishment pipe 444 extends to each developing unit 9 and is connected thereto. Each receiving port 429a, which is capable of being in communication with each discharge port 430al, is a through hole provided to penetrate the surface of the toner cartridge holder 429 that faces the rear surface of each toner cartridge 430. Each receiving port 429a is open in a direction (first direction) extending substantially along the X direction, which is the direction in which the developing units 9 are arranged side by side. The direction in which each receiving port 429a (429aY, 429aM, 429aC, and 429aK) of the toner cartridge holder 429 is open intersects with the direction in which each ejection port 80a of each pump unit 80 is open.

As shown in FIG. 6A, the upstream ends 444uY, 444uM, 444uC, and 444uK of the replenishment pipes 444 are connected to the rear surface side of the parts of the toner cartridge holder 429 where the receiving ports 429a are provided, so as to be in communication with the respective receiving ports 429a. The downstream ends 444dY, 444dM, 444dC, and 444dK of the replenishment pipes 444 are connected so as to be in communication with the connection ports 900Y, 900M, 900C, and 900K, respectively, which serve as toner receiving ports in the developing units 9. The toner received from each receiving port 429a is moved inside each replenishment pipe 444 from each upstream end 444u to each downstream end 444d by the compressed air discharged from each toner cartridge 430 and then replenished into each developing unit 9.

Next, the arrangement of each replenishment pipe 444 will be described. In FIGS. 1 and 5, the light paths L of the laser light emitted from the laser scanner unit LB are visible for convenience. The light paths L are the paths of the laser light emitted from the laser scanner unit LB toward the photosensitive drums 4Y, 4M, 4C, and 4K, respectively.

Each replenishment pipe 444 is arranged so as not to interfere with each light path L. Specifically, as shown in FIG. 1, the replenishment pipes 444Y and 444M are provided so as to extend along the end of each process cartridge P on the LE side (one side in the second direction), avoiding each light path L in the Y direction (second direction). The replenishment pipes 444C and 444K are provided so as to extend along the end of each process cartridge P on the RE side (the other side in the second direction), avoiding each light path L in the Y direction (second direction).

Each downstream end 444d of each replenishment pipe 444 is connected to an end of a toner accommodation portion 901 of each developing unit 9 in the Y direction (second direction). Specifically, the downstream end 444dY of the replenishment pipe 444Y and the downstream end 444dM of the replenishment pipe 444M are connected to the LE-side end of the developing unit 9Y and the LE-side end of the developing unit 9M, respectively. The downstream end 444dC of the replenishment pipe 444C and the downstream end 444dK of the replenishment pipe 444K are connected to the RE-side end of the developing unit 9C and the RE-side end of the developing unit 9K, respectively.

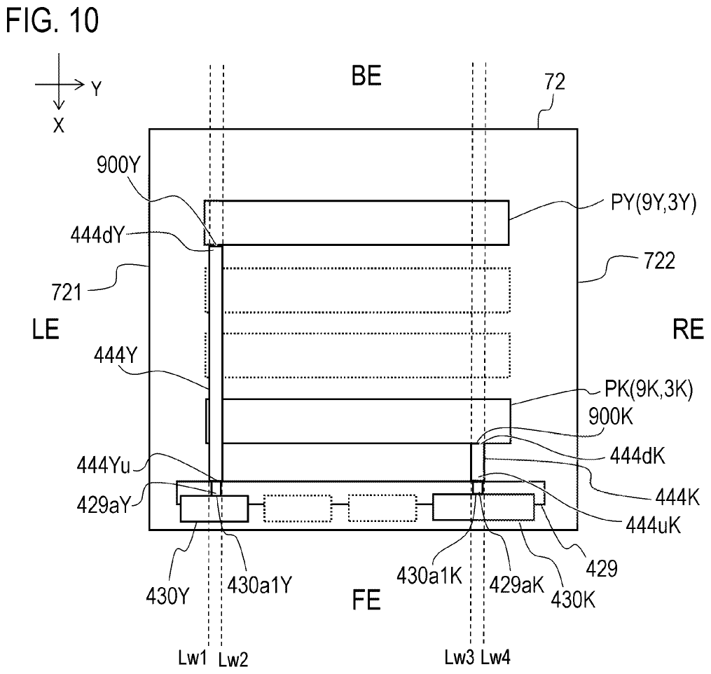

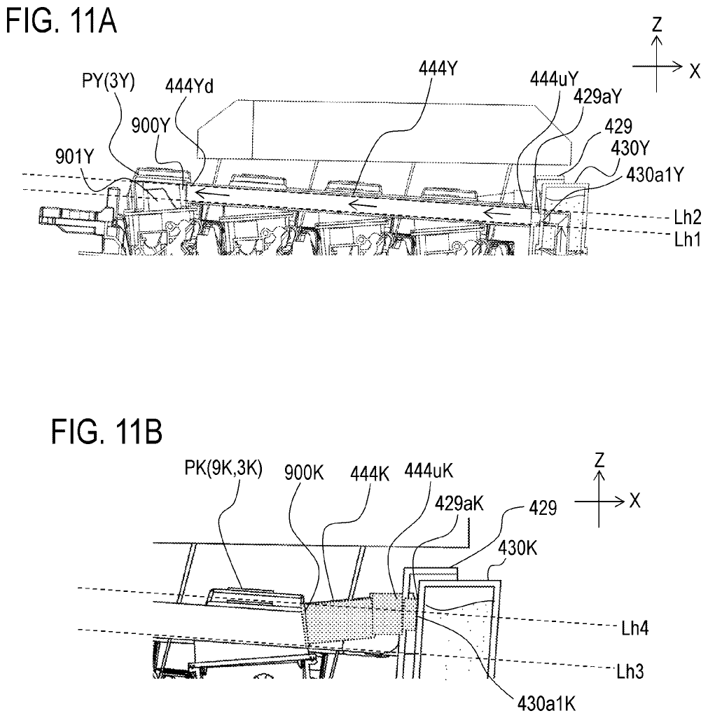

Among the replenishment pipes 444, the replenishment pipe 444Y (first replenishment pipe) will be described. The replenishment pipe 444Y (first replenishment pipe) connects the toner cartridge 430Y and the developing unit 9Y. Among the toner cartridges 430, the toner cartridge 430Y is provided at the position closest to the first end surface 721 in the Y direction among both end surfaces (the first end surface 721 and the second end surface 722; see FIGS. 3A to 3C and the like) of the apparatus main body 72 in the Y direction (second direction). Similarly, the replenishment pipe 444Y is provided at the position closest to the first end surface 721 in the Y direction. When viewed in the direction (Z direction) perpendicular to both the X direction (first direction) and the Y direction (second direction), the replenishment pipe 444Y (first replenishment pipe) is provided on the outer side of the light paths L of the laser light emitted from the laser scanner unit LB in the Y direction. The receiving port 429aY of the toner cartridge holder 429 and the connection port 900Y of the developing unit 9Y are located at the same position in the alignment direction (Y direction or second direction) of the toner cartridges 430 and located at substantially the same height in the Z direction (third direction). That is, the connection port 900Y of the developing unit 9Y is arranged to face the discharge port 430a1Y of the toner cartridge 430Y in the alignment direction (first direction) of the process cartridges P. The connection port 900Y and the discharge port 430a1Y are both open in the alignment direction (first direction) of the process cartridges P, overlap when viewed in that direction, and are positioned such that they do not overlap the light paths L of the laser light emitted from the laser scanner unit LB. Furthermore, at least a part of the receiving port 429aY (first communication port) of the toner cartridge holder 429 also overlaps the connection port 900Y (first receiving port) of the developing unit 9Y when viewed in the alignment direction (first direction) of the process cartridges P (FIGS. 10 and 11A).

FIG. 10 is a schematic plan view of the image forming apparatus 1 according to the present embodiment (as viewed in the Z direction) and schematically shows the layout of the apparatus main body 72, the process cartridges PY and PK, the toner cartridges 430Y and 430K, and the replenishment pipes 444Y and 444K. Components not required for the description are omitted in the figure. FIG. 11A is a schematic side view of the image forming apparatus 1 according to the present embodiment (as viewed in the Y direction) and schematically shows only components around the replenishment pipe 444Y in an enlarged manner. FIG. 11B is a schematic side view of the image forming apparatus 1 according to the present embodiment (as viewed in the Y direction) and schematically shows only components around the replenishment pipe 444K in an enlarged manner. As indicated by auxiliary lines Lw1 and Lw2 extending along the alignment direction (first direction) of the process cartridges P in FIG. 10, the discharge port 430a1Y, the receiving port 429aY, and the connection port 900Y are arranged such that they at least partially overlap when viewed in the alignment direction (first direction). Furthermore, in FIG. 11A, auxiliary lines Lh1 and Lh2 extend along the alignment direction (first direction) of the process cartridges P. The auxiliary line Lh1 passes through the lower end of the connection port 900Y, and the auxiliary line Lh2 passes through the upper end of the connection port 900Y. As indicated by the auxiliary lines Lh1 and Lh2, the discharge port 430a1Y, the receiving port 429aY, and the connection port 900Y are arranged such that they at least partially overlap when viewed in the alignment direction (first direction).

According to the overlapping configuration described above, it is possible to configure the toner replenishment passage from the receiving port 429aY (first communication port) of the toner cartridge holder 429 to the connection port 900Y (first receiving port) of the developing unit 9Y as a passage with reduced pressure loss. Furthermore, the replenishment pipe 444Y may be arranged to extend substantially linearly between the discharge port 430a1Y (first discharge port) and the connection port 900Y (first receiving port) when viewed in the direction perpendicular to the alignment direction (first direction) of the process cartridges P, which extends substantially along the X direction. Accordingly, by eliminating bent portions and forming a substantially linear (straight-shaped) toner conveying passage, the replenishment pipe 444Y is configured to reduce the pressure loss during the conveyance of the toner T using compressed air, thereby allowing stable toner supply. Note that the replenishment pipe 444Y is not necessarily a straight-shaped pipe, and may be, for example, a flexible tubular pipe. When the latter pipe is used, slight deflection may occur between the receiving port 429aY (first communication port) and the connection port 900Y (first receiving port). However, the above-described overlapping configuration reduces the height difference between the inlet and the outlet of the toner conveying passage, thereby realizing the above-described pressure loss reduction effect.

Among the replenishment pipes 444, the replenishment pipes 444M and 444C (second replenishment pipes) will be described. The replenishment pipes 444M and 444C are at least partially bent. The replenishment pipe 444M connects the discharge port 430a1M (second discharge port) of the toner cartridge 430M (second developer container) and the connection port 900M (second receiving port) of the developing unit 9M (second main body accommodation portion). The replenishment pipe 444C connects the discharge port 430a1C (second discharge port) of the toner cartridge 430C (second developer container) and the connection port 900C (second receiving port) of the developing unit 9C (second main body accommodation portion).

The discharge ports 430a1M and 430a1C and the connection ports 900M and 900C are arranged at positions (different positions) deviated from each other in the Y direction (second direction). The discharge ports 430a1M and 430a1C and the connection ports 900M and 900C are both open in the alignment direction (first direction) of the process cartridges P but are arranged such that they do not overlap when viewed in that direction. Furthermore, when viewed in that direction, at least the connection ports 900M and 900C are located at positions that do not overlap the light paths L of the laser light emitted from the laser scanner unit LB. Accordingly, each of the replenishment pipes 444M and 444C includes a first portion, which extends in a direction substantially along the X direction or the first direction, and a second portion, which extends in a direction substantially along the Y direction or the second direction, and is configured such that a direction in which the toner conveying passage extends changes. In the toner conveying passages formed by the replenishment pipes 444M and 444C, the first portions form downstream-side toner conveying passages, and the second portions form upstream-side toner conveying passages.

Furthermore, the first parts of the replenishment pipes 444M and 444C, which extend in the direction substantially along the X direction or the first direction, are parallel to each other and also parallel to the replenishment pipe 444Y. As shown in FIGS. 6A and 6B, the respective first parts of the replenishment pipes 444M and 444C are arranged so as to be hidden behind the replenishment pipe 444Y when viewed in the Y direction (second direction).

Among the replenishment pipes 444, the replenishment pipe 444K will be described. The replenishment pipe 444K (second replenishment pipe) connects the toner cartridge 430K and the developing unit 9K. Among the toner cartridges 430, the toner cartridge 430K is provided at the position closest to the second end surface 722 among both end surfaces (the first end surface 721 and the second end surface 722; see FIGS. 3A to 3C and the like) of the apparatus main body 72 in the Y direction (second direction). Among the replenishment pipes 444, the replenishment pipe 444K is provided at a position closer to the second end surface 722 than to the first end surface 721 in the Y direction.

Like the replenishment pipe 444Y, the replenishment pipe 444K extends substantially linearly between the discharge port 430a1K (second discharge port) of the toner cartridge 430K (second developer container) and the connection port 900K (second receiving port) of the developing unit 9K (second main body accommodation portion). However, the direction in which the replenishment pipe 444K extends differs from the direction in which the replenishment pipe 444Y extends. That is, as shown in FIG. 4B, the receiving port 429aK of the toner cartridge holder 429 is arranged at a higher position than the other receiving ports 429aY, 429aM, and 429aC in the Z direction (third direction). Correspondingly, the discharge port 430a1K of the toner cartridge 430K is arranged at a higher position in the Z direction (third direction) than the discharge ports 430a1Y, 430a1M, and 430a1C of the other toner cartridges 430Y, 430M, and 430C. On the other hand, the connection port 900K of the developing unit 9K is provided to be at the same height in the Z direction (third direction) as the connection ports 900Y, 900M, and 900C of the other developing units 9Y, 9M, and 9C when viewed in the alignment direction (first direction) of the process cartridges P. Accordingly, when viewed in the alignment direction (second direction) of the toner cartridges 430, the replenishment pipe 444K is provided to extend in a direction angled with respect to the alignment direction (first direction) of the process cartridges P. As shown in FIGS. 6A and 6B, the replenishment pipe 444K is configured to extend in a direction that intersects with the first parts of the replenishment pipes 444M and 444C and with the replenishment pipe 444Y when viewed in the Y direction (second direction).

Furthermore, as indicated by auxiliary lines Lw3 and Lw4 extending along the alignment direction (first direction) of the process cartridges P in FIG. 10, the discharge port 430a1K, the receiving port 429aK, and the connection port 900K are arranged such that they at least partially overlap when viewed in the alignment direction. Furthermore, in FIG. 11B, auxiliary lines Lh3 and Lh4 extend along the alignment direction (first direction) of the process cartridges P. The auxiliary line Lh3 passes through the lower end of the connection port 900K, and the auxiliary line Lh4 passes through the upper end of the connection port 900K. As indicated by the auxiliary lines Lh3 and Lh4, the discharge port 430a1K, the receiving port 429aK, and the connection port 900K are arranged such that they at least partially overlap when viewed in the alignment direction (first direction).

As shown in FIGS. 1, 6A, and 6B, the replenishment pipe 444K extends from the toner cartridge holder 429 to the connection port 900K of the developing unit 9K while passing through above the second part (the part extending in the Y direction (second direction)) of the replenishment pipe 444C. More specifically, the upstream end 444uK of the replenishment pipe 444K is located above the second part of the replenishment pipe 444C. Accordingly, as shown in FIG. 1, the replenishment pipe 444K and the second part of the replenishment pipe 444C are arranged to intersect with each other when viewed in the Z direction.

Furthermore, among the four replenishment pipes 444, the replenishment pipe 444K has the shortest toner conveying passage. Furthermore, the replenishment pipe 444K extends in a downward direction inclined with respect to the horizontal direction (X direction). That is, the toner conveying passage formed by the replenishment pipe 444K descends from the upstream side to the downstream side, and allows toner to be conveyed from the toner cartridge 430K to the developing unit 9K by utilizing the self-weight of the toner. Such a toner conveying passage is particularly advantageous in the toner cartridge 430K in which the replenishment frequency of the toner is relatively high and the toner accommodation amount is large.

The replenishment pipe 444Y connects the developing unit 9Y, which is arranged farthest from the toner cartridges 430 in the first direction among the developing units 9, and the toner cartridge 430Y, which is arranged at the end in the second direction among the toner cartridges 430. Furthermore, the replenishment pipe 444K connects the developing unit 9K, which is arranged closest to the toner cartridges 430 in the first direction among the developing units 9, and the toner cartridge 430K, which is arranged at the end in the second direction among the toner cartridges 430. In the present embodiment, only the replenishment pipes 444Y and 444K are linearly-extending replenishment pipes (first replenishment pipes), but this is not limiting. Depending on the arrangement or the like of the toner cartridges 430 in the Y direction (second direction), the replenishment pipes 444M and 444C, which connect the developing units 9M and 9C and the toner cartridges 430M and 430C, respectively, may also be linearly-extending replenishment pipes (first replenishment pipes).

As described above, the replenishment pipes 444, which connect the toner cartridges 430 and the developing units 9, are provided at the ends of the developing units 9 in the Y direction (second direction), avoiding the light paths L, and are arranged to form substantially straight lines when viewed in the direction substantially perpendicular to the X direction (first direction). As a result, the pressure loss during the conveyance of the toner T using compressed air is reduced, thereby allowing stable toner supply.

Note that the receiving port 429aY of the toner cartridge holder 429 and the connection port 900Y of the developing unit 9Y are described as being located at the same position in the Y direction (second direction), but this is not limiting. Even when the receiving port 429aY and the connection port 900Y are deviated in the second direction, it is possible to reduce the pressure loss by connecting the receiving port 429aY and the connection port 900Y substantially linearly (linearly in a direction slightly inclined with respect to the X direction (first direction)) while avoiding the light paths. Furthermore, the receiving port 429aY and the connection port 900Y are described as being at the same height in the Z direction (third direction), but this is not limiting. Even when the heights are different, it is possible to reduce the pressure loss by connecting the receiving port 429Y and the connection port 900Y substantially linearly.

According to the present disclosure, it is possible to improve the developer conveying performance from developer containers, which are attachable to and detachable from an apparatus main body, to the accommodation portions of the apparatus main body.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-146334, filed on Aug. 28, 2024, which is hereby incorporated by reference herein in its entirety.

What is claimed is:

1. An image forming apparatus that forms an image on a recording material, comprising:
an apparatus main body having a plurality of photosensitive drums including a first photosensitive drum, a plurality of developing units aligned in a first direction, and an air supply portion, the plurality of developing units including a first developing unit provided with a first receiving port and having a first developing roller that supplies developer received from the first receiving port to the first photosensitive drum; and
a plurality of developer containers aligned in a second direction orthogonal to the first direction, the plurality of developer containers including a first developer container that accommodates the developer, is provided with a first discharge port, and is attachable to and detachable from the apparatus main body,
wherein the apparatus main body includes
an attachment portion to and from which the plurality of developer containers is attachable and detachable, the attachment portion being provided with a first communication port that is capable of being in communication with the first discharge port, and
a plurality of pipes through which developer conveyed from the plurality of developer containers to the plurality of corresponding developing units passes by air supplied from the air supply portion, the plurality of pipes including a first pipe which extends from the first communication port to the first receiving port and through which the developer discharged from the first discharge port passes, wherein,
in a case where one end surface and the other end surface of the apparatus main body in the second direction are defined as a first end surface and a second end surface, respectively,
the first developer container is provided, in the second direction, at a position closest to the first end surface among the plurality of developer containers,
the first pipe is provided, in the second direction, at a position closest to the first end surface among the plurality of pipes, and
at least a part of the first communication port overlaps the first receiving port in a case of being viewed in the first direction.

2. The image forming apparatus according to claim 1, wherein
the first pipe extends linearly from the first communication port to the first receiving port.

3. The image forming apparatus according to claim 1, wherein
at least a part of the first communication port overlaps the first discharge port in a case of being viewed in the first direction.

4. The image forming apparatus according to claim 1, wherein
the plurality of developing units includes a second developing unit provided with a second receiving port,
the plurality of developer containers includes a second developer container that is attachable to and detachable from the apparatus main body, the second developer container accommodating developer and being provided with a second discharge port,
the attachment portion is provided with a second communication port that is in communication with the second discharge port,
the plurality of pipes includes a second pipe through which the developer discharged from the second discharge port passes, the second pipe extending from the second communication port to the second receiving port,
the second developer container is provided, in the second direction, at a position closest to the second end surface among the plurality of developer containers,
the second pipe is provided, in the second direction, at a position closer to the second end surface than the first end surface, and
at least a part of the second communication port overlaps the second receiving port in a case of being viewed in the first direction.

5. The image forming apparatus according to claim 4, wherein
at least a part of the second communication port overlaps the second discharge port in a case of being viewed in the first direction.

6. The image forming apparatus according to claim 4, wherein
the second pipe extends linearly from the second communication port to the second receiving port.

7. The image forming apparatus according to claim 4, wherein
the second developing unit is located, in the first direction, at a position closer to the plurality of developer containers than the first developing unit, and
the second pipe is shorter than the first pipe.

8. The image forming apparatus according to claim 1, wherein
the first developing unit is located, in the first direction, farthest from the plurality of developer containers among the plurality of developing units.

9. The image forming apparatus according to claim 1, wherein
the plurality of developing units includes a second developing unit provided with a second receiving port,
the plurality of developer containers includes a second developer container that is attachable to and detachable from the apparatus main body, the second developer container accommodating developer and being provided with a second discharge port,
the attachment portion is provided with a second communication port that is in communication with the second discharge port,
the plurality of pipes includes a second pipe through which the developer discharged from the second discharge port passes, the second pipe extending from the second communication port to the second receiving port,
the second developer container is provided, in the second direction, at a position closer to a center between the first end surface and the second end surface than the first developer container,
the second communication port is provided, in the second direction, at a position different from the second receiving port, the different position being a position at which the second communication port does not overlap the second receiving port in a case of being viewed in the first direction, and
at least a part of the second pipe is bent.

10. The image forming apparatus according to claim 9, wherein
the second developing unit is located, in the first direction, at a position closer to the plurality of developer containers than the first developing unit.

11. The image forming apparatus according to claim 1, wherein
the apparatus main body includes a laser scanner that irradiates a surface of the first photosensitive drum with laser light, and
the first pipe is provided, in the second direction, on an outer side of a light path of the laser light.

12. The image forming apparatus according to claim 11, wherein
the first communication port and the first receiving port are located at positions that do not overlap the light path in a case of being viewed in the first direction.

13. The image forming apparatus according to claim 1, wherein
the first developer container includes
a developer accommodation chamber that accommodates the developer and is provided with the first discharge port,
a filter that allows passage of air and prevents passage of the developer, and
an air chamber that is partitioned from the developer accommodation chamber by the filter and provided with an air receiving port for receiving air supplied from the air supply portion.

14. The image forming apparatus according to claim 13, wherein
the air receiving port is provided so as to open on a surface of the first developer container other than a surface facing the second direction.

15. The image forming apparatus according to claim 13, wherein
the developer accommodation chamber and the air chamber are aligned in a third direction intersecting with both the first direction and the second direction.

16. The image forming apparatus according to claim 15, wherein
the third direction is a gravity direction,
the air chamber is located below the developer accommodation chamber,
the discharge port is configured to be in communication with an interior of the developer accommodation chamber via a discharge pipe provided inside the developer accommodation chamber,
an opening of the discharge pipe, which opens inside the developer accommodation chamber, is provided so as to face the filter, and
the filter has a recessed shape in which a region facing the opening of the discharge pipe is recessed the deepest downward.

17. The image forming apparatus according to claim 9, wherein
the second pipe has a first portion extending in the first direction and a second portion extending in the second direction.

18. The image forming apparatus according to claim 1, wherein
the first developer container is attachable to and detachable from the attachment portion in the first direction.
